(19) United States
(12) Patent Application Publication
(10) Pub. No.: US 2018/0041952 A1
(43) Pub. Date: Feb. 8, 2018

(54) Access Control Node, Access Device, Tethering Device, and Methods Therein, for Providing Wireless Access

(71) Applicant: Telefonaktiebolaget LM Ericsson (publ), Stockholm (SE)

(72) Inventors: Selim Ickin, Stockholm (SE); Åsa Bertze, Spånga (SE); Steven Corroy, Stockholm (SE); Jing Fu, Solna (SE)

(21) Appl. No.: 14/913,717

(22) PCT Filed: Jan. 25, 2016
(86) PCT No.: PCT/EP2016/051460

§ 371 Date: Feb. 23, 2016

(51) Int. Cl. H04W 48/00; H04W 16/26

(52) U.S. Cl. CPC H04W 48/17; H04W 16/26; H04W 88/04

(57) ABSTRACT

Access control node (200), access device (202A), tethering device (204), and methods therein, for enabling wireless access to a communications network (208). One or more access devices (202) having a wireless connection to the network (208) provide (2:1) relay properties to an access control node (200). When detecting (2:2) that network access is wanted for the tethering device (204), the access control node (200) selects (2:3) an access device (202A) based on the obtained relay properties, to be used for sharing wireless connection with the tethering device (204). The access control node (200) then instructs (2:4) the selected access device (202A) to be available as a relay to the communications network (208) for the tethering device (204) via a wireless link between the access device (202A) and the tethering device (204). The tethering device (204) can then access (2:8) the communications network over the wireless link. By using the relay properties as a basis for selecting the access device (202A), the performance of the wireless network access can be improved and unwanted battery consumption can be avoided. Furthermore, no manual actions are required to achieve the wireless network access.

### TECHNICAL FIELD

The present disclosure relates generally to an access control node, an access device, a tethering device, and methods, for enabling wireless access to a communications network.

### BACKGROUND

Today, users of wireless devices usually expect to be constantly connected to the Internet regardless of time and current location. For example, the users may want to be able to retrieve information, browse web pages, send or receive emails and messages, stream media such as music, TV and movies, and so forth, always and anywhere. This can be regarded as a general growing requirement from mobile users and it is commonly referred to as “Always-Being-Connected”, ABC. Even if a user of a wireless device may want to access the Internet only occasionally, he/she wants to have the possibility to do so with the wireless device at any time and in any place.

However, sometimes it is impossible or unsuitable for a wireless device user to access a mobile or cellular network or an access point, e.g. when the user is present in a currently visited area. This may be because the user's device is not within sufficient radio coverage or does not support the radio technology and/or protocols required for the access. Even though radio coverage may be technically provided by a visited network, the extra costs for roaming outside the user's home network may further be deemed too high. Certain limitations may also be applied for visiting users, e.g. in terms of data rate and available services and features, possibly making the access less attractive. The user may also simply be denied access to a visited network, for whatever reason, e.g. when there is no agreement with the user's subscription and home operator. The above issues and restrictions typically apply when the user travels to foreign areas where wireless access to a communications network is either technically impossible or unsuitable, e.g. due to high costs and/or various limitations as explained above.

WiFi hotspots can sometimes offer wireless Internet access, often free of charge, as an alternative to mobile or cellular networks. But this option may not be available or very useful, e.g. for users of high mobility, since WiFi access is typically fixed and restricted to a few areas of limited coverage such as hotels, café s, book stores, airports and shopping areas, many of which are moreover usually closed beyond normal working hours. The user may not want to spend time searching for a WiFi hotspot every time Internet is to be accessed, which may not even be possible when travelling in a transport vehicle, sightseeing, at certain times of day, etc. WiFi may thus have quite limited availability, if at all. Further, publicly available WiFi hotspots are often overloaded with users resulting in substantial delays and interruptions of service which may be annoying or even unbearable, thus providing bad Quality of Experience, QoE, to the user.

A technique has been developed referred to as “WiFi tethering”, which enables a device user having a network connection to share his/her connectivity, e.g. mobile broadband, with other device users. This communication arrangement is illustrated in FIG. 1 where a connection to a wireless communications network 100 is shared by two wireless devices 102 and 104.

Thereby, a first wireless device 104 lacking network connection can access the Internet via another second wireless device 102 that has a network connection, by means of a local communication link 106, such as a Bluetooth link, between the two devices 102, 104. The second device 102 thus acts as a “relay” for the access to the network 100 and Internet, e.g. using a connection to a serving network node 100A such as a base station or an access point. In the following description, the first wireless device for which a network connection is wanted will be called “tethering device” and the second wireless device that has a network connection to share with others will be called “access device”. Another suitable term for the device with network connection could be “relay device” which may alternatively be used throughout this description.

The above-described tethering feature can be accomplished by means of different communication technologies for the local communication link 106 and the solutions known today include Bluetooth tethering, WiFi tethering and USB cable tethering. WiFi tethering may be regarded as an attractive solution thanks to advantages in terms of coverage range and data throughput. Billing of the tethering feature may further be done in different ways depending on the business model used, but the additional cost is not deemed to be overly high and it can be incorporated in a monthly billing scheme.

However, there are some problems associated with the above-described tethering techniques of today, mainly related to manual actions being required, degraded performance and battery power consumption.

### SUMMARY

It is an object of embodiments described herein to address at least some of the problems and issues outlined above. It is possible to achieve this object and others by using an access control node, a wireless device, and methods therein, as defined in the attached independent claims.

According to one aspect, a method is performed by an access control node for enabling wireless access to a communications network. In this method, the access control node obtains relay properties of one or more access devices having a wireless connection to the communications network. When detecting that network access is wanted for a tethering device, the access control node selects, based on the obtained relay properties, an access device of the one or more access devices to be used for sharing wireless connection to the communications network with the tethering device. The access control node then instructs the selected access device to be available as a relay to the communications network for the tethering device via a wireless link between the respective access device and the tethering device.

Thereby, no manual actions are required by any user, and the impact on the performance in one or both of the access device and the tethering device can be reduced or even minimized. Further, by selecting a suitable access device based on certain relay properties defined for the access device, any unwanted or excessive consumption of battery power and deterioration of service performance can be avoided.

According to another aspect, an access control node is arranged to enable wireless access to a communications network. The access control node is configured to obtain relay properties of one or more access devices having a wireless connection to the communications network, and to detect that network access is wanted for a tethering device. The access control node is further configured to select, based on the obtained relay properties, an access device of the one or more access devices to be used for sharing wireless connection to the communications network with the tethering device, and to instruct the selected access device to be available as a relay to the communications network for the tethering device via a wireless link between the respective access device and the tethering device.

According to another aspect, a method is performed by an access device having a wireless connection to a communications network, for enabling wireless access to the communications network for a tethering device. In this method the access device provides relay properties of the access device to an access control node, and detects that network access is wanted for the tethering device. Then the access device sends a notification to the access control node, the notification indicating that network access is wanted for the tethering device. The access device further receives an instruction from the access control node to be available for the tethering device as a relay for accessing the communications network via a wireless link between the access device and the tethering device.

According to another aspect, an access device is arranged to enable wireless access to a communications network for a tethering device when the access device has a wireless connection to the communications network. The access device is configured to provide relay properties of the access device to an access control node, and to detect that network access is wanted for the tethering device. The access device is also configured to send a notification to the access control node, the notification indicating that network access is wanted for the tethering device, and to receive an instruction from the access control node to be available for the tethering device as a relay for accessing the communications network via a wireless link between the access device and the tethering device.

According to another aspect, a method is performed by a tethering device for obtaining a wireless connection to a communications network. In this method, the tethering device transmits an access point signal to indicate that a network connection is wanted. When detecting an access point signal transmitted from an access device indicating that a network connection is available via the access device, the tethering device accesses the communications network over a wireless link between the access device and the tethering device.

According to another aspect, a tethering device is arranged to obtain a wireless connection to a communications network. The tethering device is configured to transmit an access point signal to indicate that a network connection is wanted, and to detect an access point signal transmitted from an access device indicating that a network connection is available via the access device. Responsive to detecting the access point signal from the access device, the tethering device is also configured to access the communications network over a wireless link between the access device and the tethering device.

According to another aspect, a method is provided for enabling wireless access to a communications network. The method comprises the action of providing relay properties to an access control node from one or more access devices having a wireless connection to the communications network. The method further comprises detecting, by the access control node or by the one or more access devices, that network access is wanted for a tethering device, and selecting, by the access control node, an access device of the one or more access devices based on the obtained relay properties, to be used for sharing wireless connection to the communications network with the tethering device. The method also comprises instructing, by the access control node, the selected access device to be available as a relay to the communications network for the tethering device via a wireless link between the access device and the tethering device, and accessing, by the tethering device, the communications network over the wireless link.

The above access control node, access device, tethering device and methods may be configured and implemented according to different optional embodiments to accomplish further features and benefits, to be described below.

A computer program storage product is also provided comprising instructions which, when executed on at least one processor in any of the access control node, the access device and the tethering device, cause the at least one processor to carry out a corresponding method, out of the methods described above.

### BRIEF DESCRIPTION OF DRAWINGS

The solution will now be described in more detail by means of exemplary embodiments and with reference to the accompanying drawings, in which:

FIG. 1 is a communication scenario illustrating how a wireless network connection can be shared.

FIG. 2 is a communication scenario illustrating an example of how the solution may be employed, according to some possible embodiments.

FIG. 3 is a communication scenario illustrating another example of how the solution may be employed, according to further possible embodiments.

FIG. 4 is a flow chart illustrating a procedure in an access control node, according to further possible embodiments.

FIG. 5 is a flow chart illustrating a procedure in an access device, according to further possible embodiments.

FIG. 6 is a flow chart illustrating a procedure in a tethering device, according to further possible embodiments.

FIG. 7 is a block diagram illustrating an access control node, an access device and a tethering device in more detail, according to further possible embodiments.

### DETAILED DESCRIPTION

Briefly described, a solution is provided to enable wireless access for a tethering device to a communications network by means of the above-mentioned tethering technology, without requiring specific manual actions by any user, and with reduced, or even minimized, impact on the performance in one or both of the access device and the tethering device. Embodiments described herein can also be used to avoid or reduce unwanted consumption of battery power and deterioration of service performance or QoE, by using a suitable access device that has been selected based on certain relay properties defined for the access device. The term “relay properties” is used herein to indicate that these properties are somehow indicative of how suitable the respective device is for acting as a relay for any tethering device to access the communications network.

For example, when there are more than one potential candidates available for sharing a wireless connection with a particular tethering device, the “best” or most suitable device can be selected to act as access device for the tethering device, depending on the relay properties of the candidate devices. The analysis of relay properties and selection of the best candidate device may be made by an access control node that may be implemented in, or otherwise serving, the communications network. The term “access control node” is thus used herein to represent a logic entity which basically collects and maintains relay properties of different wireless devices and selects a suitable access device therefrom whenever it is detected that network access is wanted for a tethering device.

In this solution, it has been recognized that the reasons for the above-mentioned problems of manual actions, degraded performance and unwanted battery consumption are basically as follows. Firstly, the tethering function in conventional solutions of today must be activated and deactivated manually by a user of the access device such that the tethering device user has to rely on the access device user's willingness and attention to enable a shared network access. The access device user must thus activate and later deactivate a “hotspot option” or the like on his/her device to provide network access for the tethering device for a limited duration subject to the user's initiative. The two users therefore typically need to talk to each other, or communicate in some way, and reach an agreement each time a shared network access is to be activated. The need for such manual activities can be virtually removed by embodiments described herein.

Secondly, when a tethering device is active on a network connection shared by an access device, it might happen that a service currently used by the access device itself is impacted negatively in the sense of degraded performance. For example, the data throughput may be reduced and annoying delays may also occur in the currently used service, and so forth. Such degraded performance may further occur in both devices when the shared network access is limited and the amount of available radio resources and/or network resources is small, e.g. at high traffic load. Thirdly, a battery currently powering the access device may be drained more rapidly by the added communication such that any service used by either of the tethering and access devices could be interrupted abruptly due to lack of battery power and the access device must be recharged before it can be used again at all.

As indicated above, the solution and its embodiments described herein can be used to largely avoid or at least reduce the drawbacks mentioned above, basically for the following reasons.

The procedure of enabling the wireless access by means of a selected access device according to this solution is completely automatic and no action or initiative is required from either of the users whatsoever, possibly apart from making or confirming some initial settings in the respective devices such as enabling the tethering functionality. It should be noted that both functionalities of access and tethering device may be implemented in one and the same wireless device such that the device may sometimes act as access device and at other occasions act as tethering device, depending on the situation.

Further, by using the relay properties as a basis for selecting the access device, e.g. selecting the “best” one amongst several evaluated candidate devices, a satisfactory performance of the wireless network access can be achieved and unwanted battery consumption may also be avoided or reduced. The relay properties may thus include the current location of the access device, the current battery level in the access device, various conditions and characteristics of the existing connection, any current ongoing activities in the access device, and so forth. Examples of relay properties that may be used in this solution will be described in more detail later below.

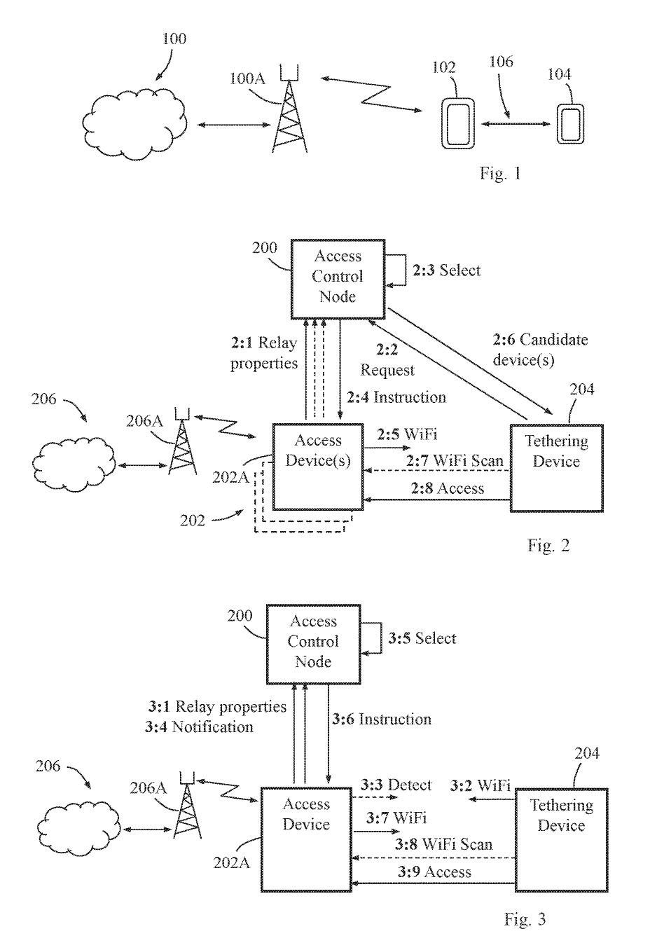

A communication scenario illustrating one non-limiting example of how the solution may be employed, will now be described with reference to FIG. 2 involving an access control node 200, a number of potential access devices 202 and a tethering device 204 for which access to a communications network 206 is wanted. There may be any reasons for wanting a network access, as discussed above, such as lack of radio coverage, high roaming costs, limited services for visitors, and so forth, and the solution is not limited to any specific reason(s) for wanting network access. It is assumed that all of the access devices 202 have an existing connection to the communications network 206, e.g. via a serving network node 206A, thereby being qualified as potential candidates for sharing their network connection with a tethering device. This procedure is further applicable for any number of candidate access devices 202 including just one device.

In this figure, a first action 2:1 illustrates that the access devices 202 provide their relay properties to the access control node 200 in which these relay properties are maintained. In this communication, the relay properties may be sent in a message using the Hyper-Text Transfer Protocol, HTTP. In this message the format of, e.g., Json or Extensible Markup Language, XML, may be used to specify different relay properties. This action may be performed on a more or less continuous basis, e.g. at regular intervals or whenever a relay property has changed, to keep the relay properties up to date in the access control node 200. The relay properties in this context thus effectively indicate how suitable and useful the respective access device is for sharing its network connection with a tethering device. Some examples of relay properties of a potential access device that may be used in this procedure, will be described later below.

In another action 2:2, the tethering device 204 in this example sends an access request to the access control node 200, the access request indicating that a wireless network connection is wanted. For example, the access request may be triggered in the tethering device 204 responsive to some specific tethering input command made by its user, or simply when the user activates an application for accessing the Internet or the like. The access request contains an identification of the tethering device 204 and possibly also its current position. By this action, the access control node 200 can detect that network access is wanted for the tethering device 204.

Another action 2:3 illustrates that the access control node 200 selects an access device 202A, out of the access devices 202, to be used for sharing wireless connection with the tethering device 204. This selection of the access device 202A is made based on the relay properties of devices 202 that were obtained in action 2:1, and possibly also based on the position of the tethering device 204 which may have been received in the access request or obtained from a positioning node in the network if available. Some examples of how the selection of access device may be performed depending on relay properties, will be described in more detail later below. It should be noted that if it is found that none of the access devices 202 is suitable for sharing network connection with the tethering device 204, e.g. by not having sufficient battery power or by being located too far away from the device 204, it may be concluded that sharing of wireless connection is not possible, or suitable, for the tethering device 204 and the access request of action 2:2 may therefore be denied in this case.

In this example, however, the access device 202A is thus selected and a next action 2:4 illustrates that the access control node 200 sends an instruction to the selected access device 202A to be available as a relay to the communications network 208 for the tethering device 204. In response thereto, the access device 202A makes itself available as relay for the network access by transmitting an access point signal, e.g. a so-called “WiFi hotspot signal”, as indicated by an action 2:5, that the tethering device 204 can detect for obtaining the network access via the access device 202A. In this description, the term “access point signal” represents a signal that a wireless device is able to transmit to indicate that the device is capable of acting as an access point for other wireless devices, which is a regular procedure as such for establishing a device to device communication. In this solution, this existing signal is utilized by the access device 202A to indicate that it can act as relay to network access for a tethering device. It is thus an advantage that wireless devices of today may already be capable of transmitting an access point signal and it is not necessary to implement any new transmission functionality to this end.

In another action 2:6, the access control node 200 may also send an indication of the selected access device 202A, or a list of multiple selected candidate devices, to the tethering device 204. Another action 2:7 illustrates that the tethering device 204 detects the access point signal by performing a WiFi scan in a conventional manner. The access point signal thus indicates to the tethering device 204 that it can use the access device's 202A existing network connection for accessing the communications network 206. Accordingly, the tethering device 204 establishes a connection with the access device 202A comprising a wireless link such as a Bluetooth connection, and accesses the communications network 206 over the wireless link, in a final shown action 2:8, which may be performed according to regular procedures not necessary to describe herein.

In the above example, it was assumed that the tethering device 204 is able to communicate with the access control node 200 in action 2:2, thus having some kind of network connection which is however deemed, for whatever reason, to be “unsuitable” to use for a wanted communication. In other circumstances the tethering device 204 may not have a network connection at all and is thus not able to send the access request of action 2:2. Another non-limiting example of how the solution may be employed in this case will now be described with reference to the communication scenario shown in FIG. 3. The entities as of FIG. 2 are involved here as well including an access control node 200, a number of potential access devices and a tethering device 204 for which access to a communications network 206 is wanted. In this example, only one access device 202A is shown for simplicity.

Similar to the example in FIG. 2, the access device 202A having a connection to the network 206 provides its relay properties to the access control node 200 in a first action 3:1, e.g. regularly or upon changed relay properties, which may also be done by further potential access devices, not shown. In this example, the tethering device 204 indicates that network access is wanted by transmitting an access point signal, e.g. a WiFi hotspot signal, as indicated by an action 3:2. As mentioned above, an access point signal can be transmitted by a wireless device in conventional procedures to indicate that the device is capable of acting as an access point for other wireless devices. In this example, the existing access point signal is utilized by the tethering device 204 in a new manner to indicate instead that network access is wanted, thus using the access point signal as an “access point wanted signal”. It is thus an advantage that wireless devices of today may already be capable of transmitting the access point wanted signal and it is not necessary to implement any new transmission functionality to this end.

The access point wanted signal of action 3:2 is detected by the access device 202A in another action 3:3, and the signal may be detected by any number of other potential access devices as well, not shown. Thereby, the access device 202A is informed that network access is wanted for the tethering device 204 and the access device 202A therefore sends a notification to the access control node 200 in a further action 3:4, the notification thus indicating that network access is wanted for the tethering device 204.

Another action 3:5 illustrates that the access control node 200 selects the access device 202A, possibly out of several potential access devices, to be used for sharing wireless connection with the tethering device 204. This selection of the access device 202A is made based on the relay properties obtained in action 3:1, which is done basically in the manner described above for action 2:3 which will therefore not be repeated here.

A next action 3:6 illustrates that the access control node 200 sends an instruction to the selected access device 202A to be available as a relay to the communications network 208 for the tethering device 204, which corresponds to action 2:4 in FIG. 2. In response thereto, the access device 202A makes itself available as relay for the network access by transmitting an access point signal, e.g. a WiFi hotspot signal, as indicated by another action 3:7 corresponding to action 2:5 in FIG. 2, that the tethering device 204 can detect for obtaining the network access via the access device 202A.

Another action 3:8 illustrates that the tethering device 204 detects the access point signal by performing a WiFi scan, which corresponds to action 2:7 in FIG. 2. Then the tethering device 204 establishes a wireless link with the access device 202A and accesses the communications network 206 over the wireless link, in a final shown action 3:9 which corresponds to action 2:8 in FIG. 2.

The procedure in any of the two examples of FIGS. 2 and 3 may be performed in different ways. For example, the access control node 200 may select more than one access device 202 in actions 2:3 and 3:5, respectively, and the instruction of actions 2:4 and 3:6 may in that case be sent to all the selected access devices 202 which accordingly will transmit the access point signal so that it is up to the tethering device 204 to use one of those access devices for obtaining the network access. In this case the tethering device 204 selects only one of the available access devices, and connects to the selected access device 202A. After the connection is established between the access device and the tethering device, the access control node 200 may need to be informed that tethering device 204 is connected to access device 202A. Thereby, the access control node can disable the access nodes that were not chosen by the tethering device to save power. In another example, the tethering device 204 may even select and use more than one access device 202 for obtaining network access by establishing a wireless links with each access device 202, e.g. to communicate multiple data flows.

It was mentioned above that the access control node 200 selects one or more access devices 202 for sharing wireless connection to the communications network with the tethering device in actions 2:3 and 3:5, respectively, based on the relay properties of the respective access devices 202. Some examples A-H of relay properties of a potential access device that may be used in this procedure, will now be described.
A) Preconditions for sharing wireless network connection. Such preconditions may have been set or confirmed by the user of the access device and may thus be more or less personalized. Alternatively, default preconditions may be confirmed by the user as valid for his/her device. The preconditions may be related to present activities in the access device and may e.g. dictate that access sharing is permitted only when the access device is not being used for any service, such as streaming of media, which could otherwise result in degraded service such as lower resolution or interruptions. Another example is that the preconditions may be related to which power source is presently used by the access device, and they may dictate that access sharing is permitted only when the access device is connected to the mains as power source, e.g. for battery charging, thus not currently consuming any power from the battery. Yet an example is that the preconditions may dictate that access sharing is permitted only during a certain time of day, or in certain days of the week. The preconditions may further dictate that access sharing is permitted only if the battery in the access device has a temperature below a certain limit which could thus indicate that battery power is currently not consumed.
B) Current location of the access device. For example, an access device may be suitable for sharing network access if it is located relatively close to the tethering device and/or to its serving network node, thus requiring low power for communication with the tethering device and/or the serving network node.
C) Current battery level in the access device. For example, an access device may be suitable for sharing network access if its battery power is sufficiently high which may also depend on how much power is currently required for communication over the existing network connection. In general, more power is typically required when the access device is located far from its serving network node than when the access device is located close thereto. Therefore, it may be valuable to consider both the current battery level and location of the access device, and possibly also the distance to the tethering device, to estimate how much battery power can be spent on the tethering device's network access.

Furthermore, various conditions of the access device's existing wireless connection to the communications network may also be included in the relay properties, and some examples D-G of such connection conditions are presented below.
D) One or more communication protocols used in the wireless connection. This may be of interest since different communication protocols may occupy different resources and equipment in the access device, and they may also require different amounts of battery power. Different communication protocols may also have different requirements in terms of latency, bitrate and communication range.
E) Average delay in the wireless connection. For example, if the average delay is currently short, e.g. depending on the amount of available radio resources in the network connection, the access device may be deemed more suitable than if the average delay is long.
F) Average data throughput in the wireless connection. For example, if the average data throughput is currently high, which may likewise depend on the amount of available radio resources in the network connection, the access device may be deemed more suitable than if the data throughput is low.
G) Connectivity drop rate in the wireless connection. For example, if the connectivity drop rate is currently low, which may depend on the radio conditions of the network connection, the access device may be deemed more suitable than if the connectivity drop rate is high.

Sometimes the evaluated access device may already be serving as a relay to the communications network for one or more other tethering devices having accessed the network earlier over a respective wireless link to the access device. In this case, some further relay properties H-I may be as follows.
H) Current total time of sharing wireless network connection with other tethering device(s). For example, if the total time of sharing wireless network connection is relatively low, the access device may be deemed more suitable than when the total sharing time is high.
I) Number of other tethering devices currently using the access device as a relay. For example, if the number of tethering devices currently using the access device as a relay is relatively low, the access device may be deemed more suitable than when that number is high.

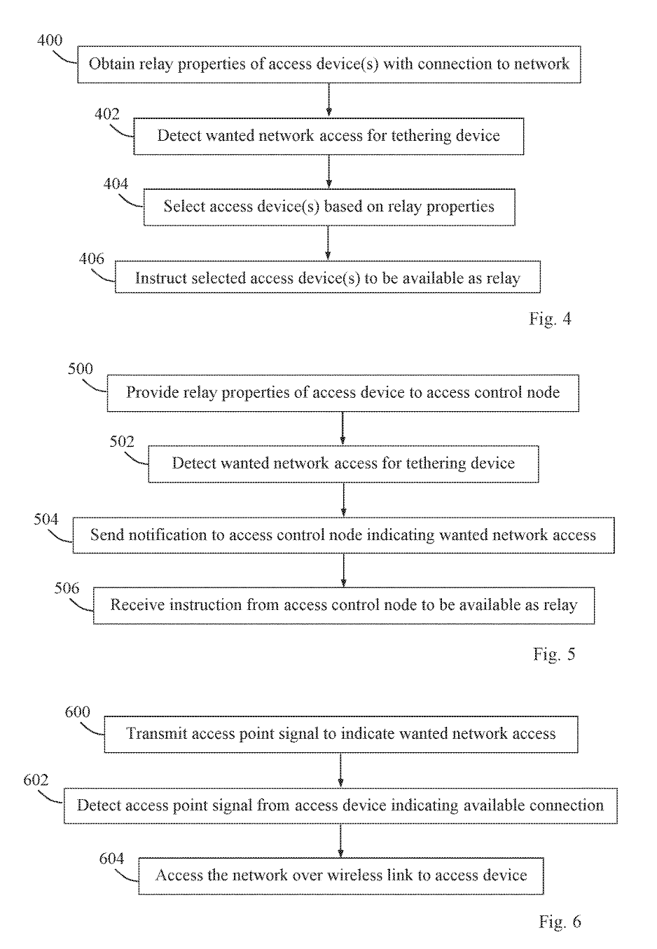

An example of how the solution may be employed in terms of actions performed in an access control node, e.g. the above-described access control node 200, for enabling wireless access to a communications network, will now be described with reference to the flow chart in FIG. 4. Reference will also be made, without limiting the features described, to the examples shown in FIGS. 2 and 3. The procedure illustrated by FIG. 4 can thus be used to accomplish the functionality described above for the access control node 200.

A first action 400 illustrates that the access control node 200 obtains relay properties of one or more access devices 202 having a wireless connection to the communications network 206. This action corresponds to the above-described actions 2:1 and 3:1. In a next action 402, the access control node detects that network access is wanted for a tethering device 202. This action corresponds to the above-described actions 2:2 and 3:4.

In a further action 404, the access control node selects, based on the obtained relay properties, an access device 202A of the one or more access devices 202 to be used for sharing wireless connection to the communications network 208 with the tethering device 204. This action may be performed in the manner described above for actions 2:3 and 3:5. A final action 406 illustrates that the access control node 200 instructs the selected access device 202A to be available as a relay to the communications network 208 for the tethering device 204 via a wireless link between the respective access device 202A and the tethering device 204. This action corresponds to the above-described actions 2:5 and 3:7.

Some non-limiting example embodiments that can be used in the above procedure, will now be described. In some possible embodiments, the relay properties of the one or more access devices 202 may indicate at least one of:
preconditions for sharing wireless network connection,
current location,
current battery level,
one or more communication protocols used in the wireless connection,
average delay in the wireless connection,
average data throughput in the wireless connection,
connectivity drop rate in the wireless connection,
current total time of sharing wireless network connection with other tethering device(s), and
number of other tethering devices currently using the respective access device 202 as a relay.

The above exemplary relay properties have been explained in more detail above. In some further possible embodiments, the above-mentioned preconditions may related to any of: time of day, battery temperature, present activities in the access device, and present power source used by the access device. The above exemplary preconditions have been explained in more detail above.

In further possible embodiments, the access control node 200 may detect that a wireless network connection is wanted by receiving an access request from the tethering device 204, such as described for action 2:2 above, or by receiving a notification from the access device 202A indicating that network access is wanted for the tethering device 204, such as described for action 3:4 above.

In another possible embodiment, the access control node 200 may select the access device 202A further based on current location of the tethering device 204. It was mentioned above that an access device may be more suitable for sharing network access when the distance to the tethering device is short than when it is long. Other possible embodiments include that the access control node 200 may select the access device 202A further based on preferences defined for one or both of the tethering device 204 and the access device 202A. Such preferences may include that the tethering device 204 and the access device 202A preferably belong, e.g. by subscription, to the same home network, or that they are preferably of a certain type, model or brand.

Another example of how the solution may be employed in terms of actions performed in an access device having a wireless connection to a communications network, e.g. the above-described access device 202A, for enabling wireless access to the communications network for a tethering device, will now be described with reference to the flow chart in FIG. 5. Reference will also be made, without limiting the features described, to the examples shown in FIGS. 2 and 3. The procedure illustrated by FIG. 5 can thus be used to accomplish the functionality described above for the access device 202A.

A first action 500 illustrates that the access device 202A provides relay properties of the access device 202A to an access control node 200. This action corresponds to the above-described actions 2:1 and 3:1. In a next action 502, the access device 202A detects that network access is wanted for the tethering device 204, e.g. corresponding to the above-described action 3:3. In a further action 504, the access device 202A sends a notification to the access control node 200, the notification indicating that network access is wanted for the tethering device 204. This action corresponds to the above-described action 3:4.

In this example it is assumed that the access control node 200 selects the access device 202A based on the obtained relay properties, as a candidate for sharing wireless connection to the communications network 208 with the tethering device 204. A final action 506 illustrates that the access device 202A accordingly receives an instruction from the access control node 200 to be available for the tethering device 204 as a relay for accessing the communications network via a wireless link between the access device 202A and the tethering device 204. Thereby, the tethering device 204 will be enabled to obtain the network access via the access device 202A.

Some non-limiting example embodiments that can be used in the above procedure, will now be described. In some possible embodiments, the relay properties provided by the access device 202A in action 500 may indicate at least one of:
preconditions for sharing wireless network connection,
current location,
current battery level,
one or more communication protocols used in the wireless connection,
average delay in the wireless connection,
average data throughput in the wireless connection,
connectivity drop rate in the wireless connection,
current total time of sharing wireless network connection with other tethering device(s), and
number of other tethering devices currently using the access device 202A as a relay.

The above exemplary relay properties have been explained in more detail above. In another possible embodiment, the access device 202A may detect that a network connection is wanted by detecting an access point signal transmitted from the tethering device 204. This embodiment corresponds to the above-described action 3:3. In another possible embodiment, the detected access point signal from the tethering device 204 may be a WiFi hotspot signal.

In another possible embodiment, the access device 202A may transmit an access point signal that the tethering device 204 can detect for obtaining the network access via the access device 202A, which corresponds to the above-described action 3:7. In another possible embodiment, the access point signal transmitted by the access device 202A may be a WiFi hotspot signal.

Another example of how the solution may be employed in terms of actions performed in a tethering device, e.g. the above-described tethering device 204, for obtaining a wireless connection to a communications network, will now be described with reference to the flow chart in FIG. 6. Reference will also be made, without limiting the features described, to the examples shown in FIGS. 2 and 3. The procedure illustrated by FIG. 6 can thus be used to accomplish the functionality described above for the tethering device 204.

A first action 600 illustrates that the tethering device 204 transmits an access point signal to indicate that a network connection is wanted, which corresponds to the above-described action 3:2. In a next action 602, the tethering device 204 detects an access point signal transmitted from an access device 202A indicating that a network connection is available via the access device 202A. This action corresponds to the above-described action 3:8. A final action 604 illustrates that the tethering device 204 accesses the communications network 208 over a wireless link between the access device 202A and the tethering device 204, which corresponds to the above-described action 3:9.

In one possible embodiment, the access point signal transmitted by the tethering device 204 may be a WiFi hotspot signal. In another possible embodiment, the detected access point signal transmitted from the access device 202A may likewise be a WiFi hotspot signal.

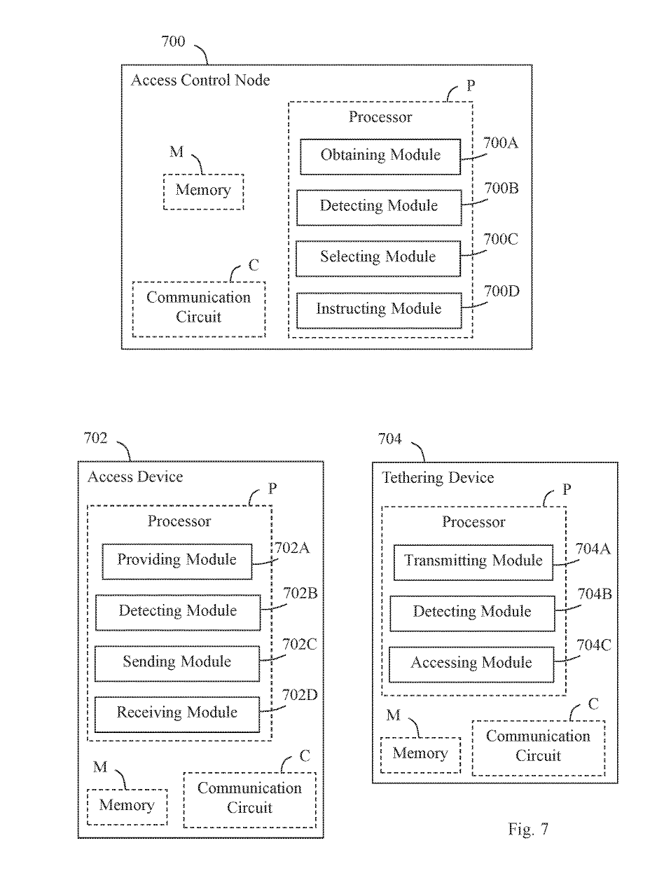

The block diagram in FIG. 7 illustrates a detailed but non-limiting example of how an access control node 700, an access device 702 and a tethering device 704, respectively, may be structured to bring about the above-described solution and embodiments thereof. In this figure, the access control node 700, the access device 702 and the tethering device 704 may be configured to operate according to any of the examples and embodiments of employing the solution as described above, where appropriate, and as follows. Each of the access control node 700, the access device 702 and the tethering device 704 is shown to comprise a processor “P”, a memory “M” and a communication circuit “C” with suitable equipment for transmitting and receiving messages in the manner described herein.

The communication circuit C in each of the access control node 700, the access device 702 and the tethering device 704 thus comprises equipment configured for the communication described herein and using one or more suitable protocols depending on the implementation. The solution is however not limited to any specific types of communication or protocols.

The access control node 700 comprises means, e.g. in the form of modules or the like, configured or arranged to perform at least some of the actions of the flow chart in FIG. 4 in the manner described herein. Further, the access device 702 comprises means, e.g. in the form of modules or the like, configured or arranged to perform at least some of the actions of the flow chart in FIG. 5 in the manner described above. Further, the tethering device 704 comprises means, e.g. in the form of modules or the like, configured or arranged to perform at least some of the actions of the flow chart in FIG. 6 in the manner described above. These actions and procedures may be performed by means of functional modules in the respective processor P in the access control node 700, the access device 702 and the tethering device 704 as follows.

The access control node 700 is arranged to enable wireless access to a communications network. The access control node 700 is configured to obtain relay properties of one or more access devices having a wireless connection to the communications network. This operation may be performed by an obtaining module 700A in the access control node 700, e.g. as described for action 400. The access control node 700 is further configured to detect that network access is wanted for a tethering device 704. This operation may be performed by a detecting module 700B in the access control node 700, e.g. as described for action 402.

The access control node 700 is also configured to select, based on the obtained relay properties, an access device 702 of the one or more access devices to be used for sharing wireless connection to the communications network with the tethering device. This operation may be performed by a selecting module 700C in the access control node 700, e.g. as described for action 404. The access control node 700 is further configured to instruct the selected access device 702 to be available as a relay to the communications network for the tethering device 704 via a wireless link between the respective access device 702 and the tethering device 704. This operation may be performed by an instructing module 700D in the access control node 700, e.g. as described for action 406.

The access device 702 is arranged to enable wireless access to a communications network for a tethering device 704 when the access device 702 has a wireless connection to the communications network. The access device 702 is configured to provide relay properties of the access device 702 to an access control node 700. This operation may be performed by a providing module 702A in the access device 702, e.g. in the manner described for action 500. The access device 702 is further configured to detect that network access is wanted for the tethering device 704. This operation may be performed by a detecting module 702B in the access device 702, e.g. in the manner described for action 502.

The access device 702 is also configured to send a notification to the access control node 700, the notification indicating that network access is wanted for the tethering device 704. This operation may be performed by a sending module 702C in the access device 702, e.g. in the manner described for action 504. The access device 702 is further configured to receive an instruction from the access control node 700 to be available for the tethering device 704 as a relay for accessing the communications network via a wireless link between the access device 702 and the tethering device 704. This operation may be performed by a receiving module 702D in the access device 702, e.g. in the manner described for action 506.

The tethering device 704 is arranged to obtain a wireless connection to a communications network. The tethering device 704 is configured to transmit an access point signal to indicate that a network connection is wanted. This operation may be performed by a transmitting module 704A in the tethering device 704, e.g. in the manner described for action 600. The access point signal is thus utilized by the tethering device 704 as an “access point wanted signal”. The tethering device 704 is further configured to detect an access point signal transmitted from an access device 702 indicating that a network connection is available via the access device 702. This operation may be performed by a detecting module 704B in the tethering device 704, e.g. in the manner described for action 602.

The tethering device 704 is also configured to access the communications network over a wireless link between the access device 702 and the tethering device 704. This operation may be performed by an accessing module 704C in the tethering device 704, e.g. in the manner described for action 604.

It should be noted that FIG. 7 illustrates various functional modules in the access control node 700, the access device 702 and the tethering device 704, respectively, and the skilled person is able to implement these functional modules in practice using suitable software and hardware. Thus, the solution is generally not limited to the shown structures of the access control node 700, the access device 702 and the tethering device 704, and the functional modules therein may be configured to operate according to any of the features and embodiments described in this disclosure, where appropriate.

The functional modules 700A-D, 702A-D and 704A-C described above can be implemented in the access control node 700, the access device 702 and the tethering device 704, respectively, by means of program modules of a respective computer program comprising code means which, when run by the processor P causes the access control node 700, the access device 702 and the tethering device 704 to perform the above-described actions and procedures. Each processor P may comprise a single Central Processing Unit (CPU), or could comprise two or more processing units. For example, each processor P may include a general purpose microprocessor, an instruction set processor and/or related chips sets and/or a special purpose microprocessor such as an Application Specific Integrated Circuit (ASIC). Each processor P may also comprise a storage for caching purposes.

Each computer program may be carried by a computer program product in each of the access control node 700, the access device 702 and the tethering device 704 in the form of a memory having a computer readable medium and being connected to the processor P. The computer program product or memory M in each of the access control node 700, the access device 702 and the tethering device 704 thus comprises a computer readable medium on which the computer program is stored e.g. in the form of computer program modules or the like. For example, the memory M in each node may be a flash memory, a Random-Access Memory (RAM), a Read-Only Memory (ROM) or an Electrically Erasable Programmable ROM (EEPROM), and the program modules could in alternative embodiments be distributed on different computer program products in the form of memories within the respective access control node 700, access device 702 and tethering device 704.

The solution described herein may be implemented in each of the access control node 700, the access device 702 and the tethering device 704 by a computer program comprising instructions which, when executed on at least one processor, cause the at least one processor to carry out the actions according to any of the above embodiments, where appropriate. The solution may also be implemented at each of the access control node 700, the access device 702 and the tethering device 704 in a carrier containing the above computer program, wherein the carrier is one of an electronic signal, optical signal, radio signal, or computer readable storage medium.

The solution may further be described in terms of a method for enabling wireless access to a communications network. This method comprises the following actions 1-5:

1) Providing relay properties to an access control node from one or more access devices having a wireless connection to the communications network. This action corresponds to the above-described actions 2:1, 3:1, 400 and 500.
2) Detecting, by the access control node or by the one or more access devices, that network access is wanted for a tethering device. This action corresponds to the above-described actions 2:2, 3:3, 402 and 502.
3) Selecting, by the access control node, an access device of the one or more access devices based on the obtained relay properties, to be used for sharing wireless connection to the communications network with the tethering device. This action corresponds to the above-described actions 2:3, 3:5 and 404.
4) Instructing, by the access control node, the selected access device to be available as a relay to the communications network for the tethering device via a wireless link between the access device and the tethering device. This action corresponds to the above-described actions 2:4, 3:6, 406 and 506.
5) Accessing, by the tethering device, the communications network over the wireless link. This action corresponds to the above-described actions 2:8, 3:9 and 604.

While the solution has been described with reference to specific exemplifying embodiments, the description is generally only intended to illustrate the inventive concept and should not be taken as limiting the scope of the solution. For example, the terms “access control node”, “wireless device”, “tethering device”, “access device”, “relay”, and “relay properties” have been used throughout this disclosure, although any other corresponding entities, functions, and/or parameters could also be used having the features and characteristics described here. The solution is defined by the appended claims.

1-32. (canceled)

33. A method performed by an access control node for enabling wireless access to a communications network, the method comprising:
obtaining relay properties of one or more access devices having a wireless connection to the communications network;
detecting that network access is wanted for a tethering device;
selecting, based on the obtained relay properties, an access device of the one or more access devices to be used for sharing wireless connection to the communications network with the tethering device; and
instructing the selected access device to be available as a relay to the communications network for the tethering device via a wireless link between the respective access device and the tethering device.

34. The method of claim 33, wherein the relay properties of the one or more access devices indicate at least one of:
preconditions for sharing wireless network connection;
current location;
current battery level;
one or more communication protocols used in the wireless connection;
average delay in the wireless connection;
average data throughput in the wireless connection;
connectivity drop rate in the wireless connection;
current total time of sharing wireless network connection with other tethering device(s); and
number of other tethering devices currently using the respective access device as a relay.

35. The method of claim 34, wherein said preconditions are related to any of: time of day, battery temperature, present activities in the access device, and present power source used by the access device.

36. The method of claim 33, wherein the access control node detects that a wireless network connection is wanted by receiving an access request from the tethering device or by receiving a notification from the access device indicating that network access is wanted for the tethering device.

37. The method of claim 33, wherein the access device is selected further based on current location of the tethering device.

38. The method of claim 33, wherein the access device is selected further based on preferences defined for one or both of the tethering device and the access device.

39. An access control node arranged to enable wireless access to a communications network, the access control node comprising:
a communication circuit configured to wirelessly transmit and receive messages; and
a processing circuit that comprises a processor and a memory;
wherein the processing circuit is configured to:
obtain relay properties of one or more access devices having a wireless connection to the communications network;
detect that network access is wanted for a tethering device;
select, based on the obtained relay properties, an access device of the one or more access devices to be used for sharing wireless connection to the communications network with the tethering device; and
instruct the selected access device to be available as a relay to the communications network for the tethering device via a wireless link between the respective access device and the tethering device.

40. The access control node of claim 39, wherein the relay properties of the one or more access devices indicate at least one of:
preconditions for sharing wireless network connection;
current location;
current battery level;
one or more communication protocols used in the wireless connection;
average delay in the wireless connection;
average data throughput in the wireless connection;
connectivity drop rate in the wireless connection;
current total time of sharing wireless network connection with other tethering device(s); and
number of other tethering devices currently using the respective access device as a relay.

41. The access control node of claim 40, wherein said preconditions are related to any of: time of day, battery temperature, present activities in the access device, and present power source used by the access device.

42. The access control node of claim 39, wherein the processing circuit is configured to detect that a wireless network connection is wanted by receiving an access request from the tethering device or by receiving a notification from the access device indicating that network access is wanted for the tethering device.

43. The access control node of claim 39, wherein the processing circuit is configured to select the access device further based on current location of the tethering device.

44. The access control node of claim 39, wherein the processing circuit is configured to select the access device further based on preferences defined for one or both of the tethering device and the access device.

45. A method performed by an access device having a wireless connection to a communications network, for enabling wireless access to the communications network for a tethering device, the method comprising:
providing relay properties of the access device to an access control node;
detecting that network access is wanted for the tethering device;
sending a notification to the access control node, the notification indicating that network access is wanted for the tethering device; and
receiving an instruction from the access control node to be available for the tethering device as a relay for accessing the communications network via a wireless link between the access device and the tethering device.

46. The method of claim 45, wherein the provided relay properties indicate at least one of:
preconditions for sharing wireless network connection;
current location;
current battery level;
one or more communication protocols used in the wireless connection;
average delay in the wireless connection;
average data throughput in the wireless connection;
connectivity drop rate in the wireless connection;
current total time of sharing wireless network connection with other tethering device(s); and
number of other tethering devices currently using the access device as a relay.

47. The method of claim 45, wherein the access device detects that a network connection is wanted by detecting an access point signal transmitted from the tethering device.

48. The method of claim 47, wherein the detected access point signal is a WiFi hotspot signal.

49. The method of claim 45, wherein the access device transmits an access point signal that the tethering device can detect for obtaining the network access via the access device.

50. The method of claim 49, wherein the transmitted access point signal is a WiFi hotspot signal.

51. An access device arranged to enable wireless access to a communications network for a tethering device when the access device has a wireless connection to the communications network, the access device comprising:
a communication circuit configured to wirelessly transmit and receive messages; and
a processing circuit that comprises a processor and a memory;
wherein the processing circuit is configured to:
provide relay properties of the access device to an access control node;
detect that network access is wanted for the tethering device;
send a notification to the access control node, via the communication circuit, the notification indicating that network access is wanted for the tethering device; and
receive, via the communication circuit, an instruction from the access control node to be available for the tethering device as a relay for accessing the communications network via a wireless link between the access device and the tethering device.

52. The access device of claim 51, wherein the provided relay properties indicate at least one of:
preconditions for sharing wireless network connection;
current location;
current battery level;
one or more communication protocols used in the wireless connection;
average delay in the wireless connection;
average data throughput in the wireless connection;
connectivity drop rate in the wireless connection;
current total time of sharing wireless network connection with other tethering device(s); and
number of other tethering devices currently using the access device as a relay.

53. The access device of claim 51, wherein the processing circuit is configured to detect that a network connection is wanted by detecting an access point signal transmitted from the tethering device.

54. The access device of claim 53, wherein the detected access point signal is a WiFi hotspot signal.

55. The access device of claim 51, wherein the processing circuit is configured to transmit an access point signal that the tethering device can detect for obtaining the network access via the access device.

56. The access device of claim 55, wherein the transmitted access point signal is a WiFi hotspot signal.

57. A method performed by a tethering device for obtaining a wireless connection to a communications network, the method comprising:
transmitting an access point signal to indicate that a network connection is wanted;
detecting an access point signal transmitted from an access device indicating that a network connection is available via the access device; and
accessing the communications network over a wireless link between the access device and the tethering device.

58. The method of claim 57, wherein the transmitted access point signal is a WiFi hotspot signal.

59. The method of claim 57, wherein the detected access point signal transmitted from the access device is a WiFi hotspot signal.

60. A tethering device arranged to obtain a wireless connection to a communications network, the tethering device comprising:
a communication circuit configured to wirelessly transmit and receive messages; and
a processing circuit that comprises a processor and a memory;
wherein the processing circuit is configured to:
transmit an access point signal, via the communication circuit, to indicate that a network connection is wanted;
detect an access point signal transmitted from an access device indicating that a network connection is available via the access device; and
access the communications network over a wireless link between the access device and the tethering device.

61. The tethering device of claim 60, wherein the transmitted access point signal is a WiFi hotspot signal.

62. The tethering device of claim 60, wherein the detected access point signal transmitted from the access device is a WiFi hotspot signal.

63. A method for enabling wireless access to a communications network, the method comprising:
providing relay properties to an access control node from one or more access devices having a wireless connection to the communications network;
detecting, by the access control node or by the one or more access devices, that network access is wanted for a tethering device;
selecting, by the access control node, an access device of the one or more access devices based on the obtained relay properties, to be used for sharing wireless connection to the communications network with the tethering device;
instructing, by the access control node, the selected access device to be available as a relay to the communications network for the tethering device via a wireless link between the access device and the tethering device; and
accessing, by the tethering device, the communications network over the wireless link.
